(19) United States
(12) Patent Application Publication
(10) Pub. No.: US 2008/0284561 A1
(43) Pub. Date: Nov. 20, 2008

(54) Method for protecting data

(75) Inventors: Ting-Chuan Chang, Taipei (TW); Ching Hui Li, Taipei (TW); Hung-Ju Chang, Taipei (TW); Yu-Mei Hung, Taipei (TW); Chi-Fen Chiang, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/798,357

(22) Filed: May 14, 2007

(51) Int. Cl. G08B 29/00

(52) U.S. Cl. 340/5.6

(57) ABSTRACT

The present invention is to provide a method for protecting data applied to an electronic communication device, which enables the electronic communication device to receive a wireless signal containing a data output instruction transmitted by a user of the electronic communication device when the electronic communication device is stolen or lost, output a plurality of preset protected data stored in the electronic communication device to an external storage device, and delete the preset protected data from the electronic communication device so that the preset protected data no more exists in the electronic communication device and can't be used by others who picked up or stole the electronic communication device.

### FIELD OF THE INVENTION

The present invention relates to a method for protecting data, more particularly to a method for protecting data applied to an electronic communication device for outputting and deleting preset protected data stored therein while the electronic communication device receives a data output instruction.

### BACKGROUND OF THE INVENTION

An information era associated with a rapidly developed electronic technology is merging with mankind life. High-tech electronic products derived from kinds of digital technologies facilitate human's science and technology for advancing. The high-tech products, mobile communication products derived from current computers are rapidly developed and widely related with our daily life, and shorten distances among people both of time and space.

Cell phones, which have already became indispensable tools of human's daily life, are not only adapted to transmit information outwardly, but also capable of word processing, important information memo, and time scheduling. As such, many currently used cell phones contain lots of important and very private information stored therein, and once such a cell phone was unfortunately stolen or lost, information contained therein are likely to reversely become a threat to privacy security of the owner.

### SUMMARY OF THE INVENTION

In order to lower the danger of confidential information contained in a lost or stolen electronic communication device to be breached, the inventor of the present invention based on years of experience to conduct extensive researches and experiments and finally invented a method for protecting data and lowering the danger of confidential information contained in a lost or stolen electronic communication device to be breached, and thus protecting security of privacy, life and property of the owner.

The present invention is directed to provide a method for protecting data, applied to an electronic communication device. According to the method for protecting data, when the electronic communication device is stolen or lost, the user of the electronic communication device can transmit a wireless signal containing a data output instruction. When the electronic communication device receives the wireless signal and the data output instruction is determined, it outputs a plurality of preset protected data. Then, the electronic communication device deletes the preset protected data so that the preset protected data stored in the electronic communication device can not be used again.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a block diagram illustrating the electronic apparatus according to an embodiment of the present invention;

FIG. 2 is a schematic diagram illustrating a data protecting table according to an embodiment of the present invention;

FIG. 3 is flow chart of an embodiment of the present invention;

FIG. 4 is a flow chart of a preferred embodiment of determining whether there is an output flag according to the present invention; and

FIG. 5 is a flow chart of a preferred embodiment of determining whether to enable a backup power module according to the present invention.

### DETAILED DESCRIPTION OF THE PREFERRED EMBODIMENTS

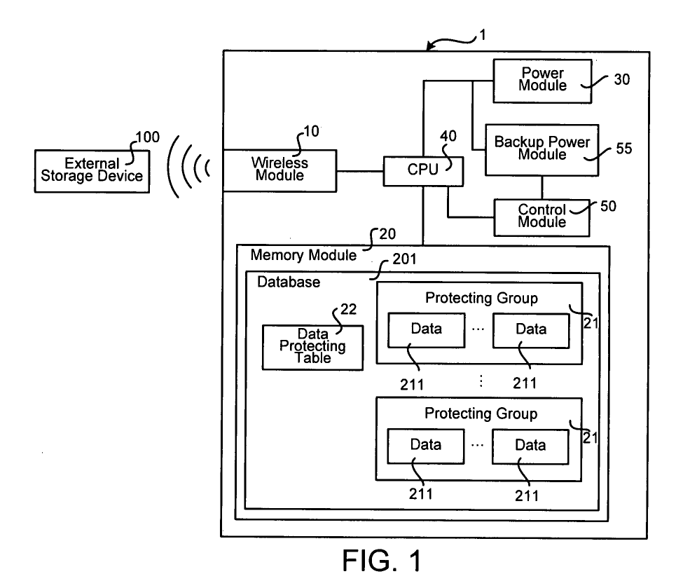

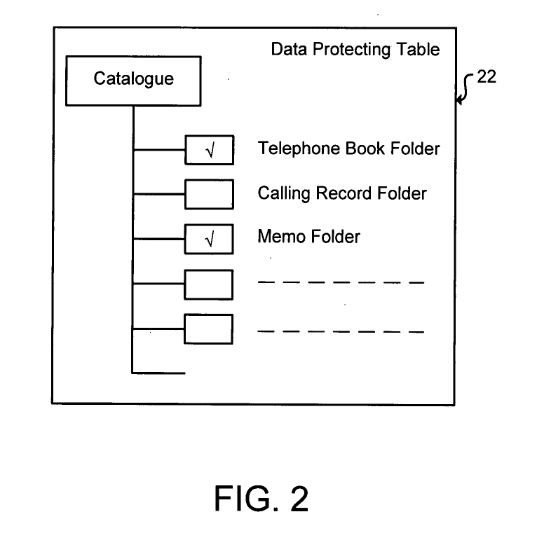

The present invention is to provide a method for protecting data, applied to an electronic communication device 1, e.g., a cell phone, a PDA, as shown in FIGS. 1 and 2. When the electronic communication device 1 receives a wireless signal from user, the electronic communication device 1 performs a decoding calculation to the wireless signal, and determines whether this wireless signal is a data output instruction. When it is determined that the wireless signal is a data output instruction, the electronic communication device 1 outputs a plurality of preset protected data (e.g., photo album, contact book, calendar, and short message stored therein) to a predetermined external storage device (e.g., an email box or another electronic communication device). Then, after outputting this preset protected data, the electronic communication device 1 deletes these preset protected data therefrom.

According to a preferred embodiment of the present invention, and referring to FIGS. 1 and 2, the electronic communication device 1 includes a wireless module 10 (e.g., wireless transmitter), a memory module 20, a power module 30 (e.g., a rechargeable battery), and a central processing unit (CPU) 40. The power module 30 is adapted to provide power for all operation of the electronic communication device 1 when being switched on, and the wireless module 10 is adapted to process communication data according to a communication protocol.

The communication protocol for example is one of General Packet Radio Service (GPRS), Global System for Mobile communication (GSM), Infrared Rays, Radio Frequency (RF), and Bluetooth.

The memory module 20 includes a database 201. The database 201 includes a plurality of protecting groups 21, e.g., photo album, contact book, calendar, and short messages stored in the electronic communication device 1. The protecting groups 21 include a plurality of protected data 211, e.g., names, phone numbers, addresses, birthdays, working places, or secret code of bank account. The database 201 further includes a data protecting table 22 for allowing a user to select the protected data 211 of the protecting groups 21. The selected protected data 211 are hereby defined as preset protected data. The CPU 40 is coupled to the wireless module 10, the power module 30, and the memory module 20, respectively. When the CPU 40 determines that the wireless signal is a data output instruction, the wireless module 10 outputs the protected data 211 to an external storage device 100, e.g., an email box or another electronic communication device, and thereafter deleting the protected data in the memory module 20.

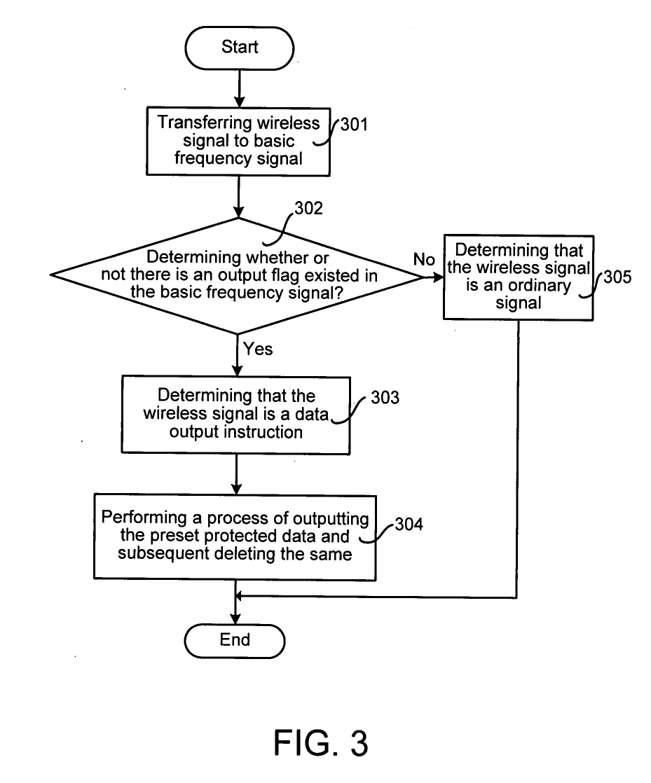

According to the embodiment, and again referring to FIGS. 1 and 2, the user transmits a wireless signal directly to the electronic communication device 1 by another communication device, e.g., intranet, internet, GPRS network, GSM network, personal handyphone system (PHS) network, or public switched telephone network (PSTN). After receiving the wireless signal, the CPU 40 processes the following steps as shown in FIG. 3:

(301) transferring the received wireless signal, so that a plurality of data packets that contain high frequency signals in the wireless signal can be converted into a basic frequency signal that can be processed by the electronic communication device 1 by a decoding calculation procedure, e.g., decapsulation;

(302) determining whether or not there is an output flag existed in a flag column of the basic frequency signal upon which it can be determined whether to delete the preset protected data later, and if there is such an output flag, then going to step (303), and otherwise going to step (305);

(303) determining that the received wireless signal is a data output instruction by determining that there is an output flag existed in the flag column;

(304) performing a process of outputting the preset protected data and subsequently deleting the same, and then ending the process.

(305) determining that there is no such an output flag existed in the flag column, by which the CPU 40 being aware of that the wireless signal is an ordinary signal received by the electronic communication device 1 during a routine operation, e.g., a signal switching instruction, a voice signal, a text signal, and thus ending the process.

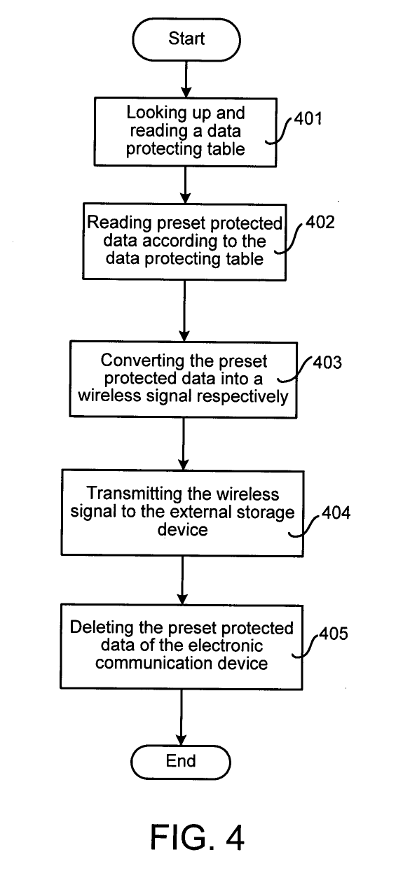

According to the present invention, and still referring to FIGS. 1 and 2, when the CPU 40 determines that the received wireless signal is a data output instruction, the CPU 40 performs the following steps as shown in FIG. 4 to delete the preset protected data:

(401) looking up and reading the protected data 211 of the protecting groups 21 in the data protecting table 22, the protected data 211 of the protecting groups 21 being hereby defined as preset protected data;

(402) reading the preset protected data of the protecting groups 21 from the database 201, according to the protected data 211 in the data protecting table 22;

(403) performing an encoding calculation procedure to convert the preset protected data in the protecting groups 21 into a wireless signal consistent to a communication protocol of the wireless module 10;

(404) the wireless module 10 outwardly transmitting the wireless signal directly to, or via a public network, e.g., intranet, internet, GPRS network, GSM network, PHS network, or PSTN, to the external storage device 100; and

(405) sequentially deleting the preset protected data of the protecting groups 21, according to the preset protected data in the data protecting table 22.

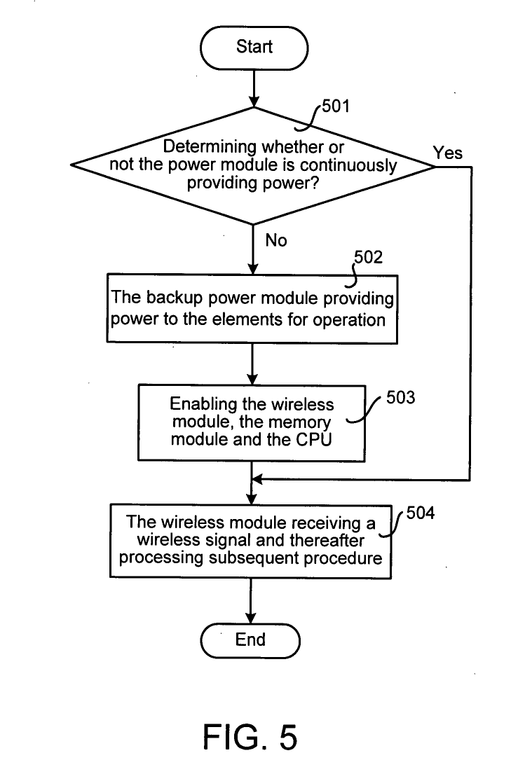

Further, supposing in case the electronic communication device 1 is stolen or lost, and the one who steals or picks it may switch off the electronic communication device 1 for avoiding from being called or positioned by the owner of the electronic communication device 1, e.g., positioning the location of the electronic communication device 1 by a police department or a telecommunication service provider via a base station. When the electronic communication device 1 is turned off and has no power supplied thereto, the CPU 40 can not be enabled. As such, according to an embodiment of the present invention, as shown in FIG. 1, the electronic communication device 1 further includes a backup power module 55, e.g., a rechargeable battery adapted to be charged together with the power module 30, and a control module 50, e.g., an integrated microchip. The backup power module 55 is adapted to be enabled by the control module 50 after the electronic communication device 1 being turned off, i.e., the power module 30 does not provide power for a certain period, e.g., 2 to 3 hours. In such a way, the backup power module 55 provides power to the control module 50, the wireless module 10, the memory module 20 and the CPU 40 for operation. As shown in FIG. 5, after the electronic communication device 1 is turned off, the control module 50 performs the following steps to receive the wireless signal and performs the subsequent procedure:

(501) detecting a power outputted from the power module 30, and determining whether or not the power module 30 is continuously providing power; if yes, then going to step (504), and if no then going to step (502);

(502) enabling the connection between the backup power module 55 and respectively the control module 50, the wireless module 10, the memory module 20, and the CPU 40 to provide power thereto for operation;

(503) enabling the wireless module 10, the memory module 20 and the CPU 40 for normal operation; and

(504) the wireless module receiving a wireless signal, and converting the received wireless signal, e.g., step (301), and performing the subsequent procedures. While the invention herein disclosed has been described by means of specific embodiments, numerous modifications and variations could be made thereto by those skilled in the art without departing from the scope and spirit of the invention set forth in the claims.

What is claimed is:

1. A method for protecting data, applied to an electronic communication device, the method for protecting data comprising the steps of:
receiving a wireless signal;
performing a decoding calculation to the wireless signal, and determining whether or not the wireless signal is a data output instruction;
when it is determined that the wireless signal is a data output instruction, then outputting a plurality of preset protected data; and
deleting the preset protected data.

2. The method for protecting data as set forth in claim 1, wherein the step of determining whether the wireless signal is a data output instruction comprises:
determining whether or not there is an output flag existed in a plurality of bites of the wireless signal;
determining that the received wireless signal is a data output instruction when there is the output flag existed in the bites; and
determining that the received wireless signal is an ordinary signal when there isn't the output flag existed in the bites.

3. The method for protecting data as set forth in claim 2, wherein the ordinary signal is a signal switching instruction.

4. The method for protecting data as set forth in claim 2, wherein the ordinary signal is a voice signal.

5. The method for protecting data as set forth in claim 2, wherein the ordinary signal is a text signal.

6. The method for protecting data as set forth in claim 1, wherein the step of outputting the preset protected data comprises:
reading a data protecting table from a database;
according to at least one protecting group of the data protecting table to fetch a data of the at least one protecting group, and defining the data of the at least one protecting group as the plurality of preset protected data; and
outputting the plurality of preset protected data to an external storage device.

7. The method for protecting data as set forth in claim 6, wherein the protecting group is a contact book of the electronic communication device.

8. The method for protecting data as set forth in claim 6, wherein the protecting group is a photo album of the electronic communication device.

9. The method for protecting data as set forth in claim 6, wherein the protecting group is a calendar of the electronic communication device.

10. The method for protecting data as set forth in claim 6, wherein the protecting group is a short message of the electronic communication device.

11. The method for protecting data as set forth in claim 1, wherein the decoding calculation comprises converting the wireless signal from a high frequency signal to a basic frequency signal.
